(19) United States
(12) Patent Application Publication
(10) Pub. No.: US 2007/0271796 A1
(43) Pub. Date: Nov. 29, 2007

(54) Scraper having weighted cutting head for removing nail heads and other debris from surfaces

(76) Inventors: George L. Oikarinen, Calumet, MI (US); Scott F. Zenner, Houghton, MI (US)

Correspondence Address: REISING, ETHINGTON, BARNES, KISSELLE, P.C., P O BOX 4390, TROY, MI, 48099-4390, US

(21) Appl. No.: 11/355,528

(22) Filed: Feb. 16, 2006

(51) Int. Cl. B26B 3/00

(52) U.S. Cl. 30/169; 30/167; 30/168

(57) ABSTRACT

A scraper for removing nail heads and other debris from a surface which comprises a handle, a weighted cutting head and a mechanism for attaching the handle to the weighted cutting head. When a hand of a user grasps the handle and the weighted cutting head is moved upon the surface, sufficient momentum will be provided to easily scrape away nail heads and other debris with little effort.

### BACKGROUND OF THE INVENTION

1. Field of the Invention

The present invention relates to a scraping tool, and more particularly, a scraper for removing nail heads and other debris from a surface.

2. Description of the Prior Art

Numerous innovations for cutting tools have been provided in the prior art that will be described. Even though these innovations may be suitable for the specific individual purposes to which they address, however, they differ from the present invention.

A FIRST EXAMPLE, U.S. Patent Office Document No. 1,327,155, Issued on Jan. 06, 1920, to Gottschalk teaches a scraper having an elongated body portion, a forward, downwardly curved end, a flexible spring cutting blade adjustably held in the scraper, means for rigidly clamping the blade in place, and a longitudinal recess allowing the rear end of the blade to be engaged for adjusting the same in the scraper to various positions therein.

A SECOND EXAMPLE, U.S. Patent Office Document No. 2,215,216, Issued on Sep. 17, 1940, to Gits et al. teaches a cutting implement comprising a handle and a blade housing extending from the handle, a compartment in the housing, a cutting blade projecting from the compartment, manually operable means projecting from the housing for adjustably moving the blade at predetermined distances from the compartment to effect cutting operations at different depths, and means for connecting the blade and the manually operable means whereby the blade will be locked in its different positions of adjustment comprising a pair of shoulders carried by and disposed intermediate the ends of the blade, a spring member having its ends seated against the shoulder and carrying the manually operable means, and locking lugs on the manually operable means adapted to be released from locking position by depressing the spring member when the manually operable means is actuated to move the blade.

A THIRD EXAMPLE, U.S. Patent Office Document No. 3,726,010, Issued on Apr. 10, 1973, to Yokoyama teaches a carpet cutter comprising a body having a handle or grip in the upper part thereof, and a blade which is retentively secured in such a manner that its position is variable, if necessary, within a range of positions from the front face of the handle or grip to the front face of the body. The blade is provided with an edge on a lateral side thereof. The underside of the body is a plane making an acute angle in relation to the edge of the blade. The front end of the blade is adapted to be upwardly protrudable beyond the front edge of the underside of the body.

A FOURTH EXAMPLE, U.S. Patent Office Document No. 3,893,238, Issued on Jul. 08, 1975, to Scholl teaches a hand operated tool for cutting relatively heavy paper and plasticized wall coverings, cork, carpet and like materials. A cutting blade is held by a manually engageable holder in bi-angular relation to the plane of the material to be cut. As the tool advances along a desired cutting line, the material is severed in a plane disposed in acute angular relationship to the plane of the material. The effect of this provides an undercut edge on the material whereby such edge may be arranged in overlapping relationship with a matingly angulated edge of adjacent material to produce a seamless butt joint. The blade cooperates with an underlying guide shoe and material guiding means in making the angulated cut. Inversion of the tool presents a second knife edge for cutting the material at matching angles in those instances where the guide shoe cannot be employed.

A FIFTH EXAMPLE, U.S. Patent Office Document No. 3,991,467, Issued on Nov. 16, 1976, to Yokoyama teaches a carpeting trimmer which includes a body consisting of a base having a flat bottom and upwardly extending grip, a channel extending through the body and slidably accommodating a blade, a base plate mounted below the base of the body, and a disc having a screw threaded in the bottom of the base. The base plate is movable towards and away from the bottom of the base in such a manner that the front edge of the base plate retreats behind the front edge of the base. The disc is arranged between the bottom of the base and the base plate for supporting the latter.

A SIXTH EXAMPLE, U.S. Patent Office Document No. 5,203,086, Issued on Apr. 20, 1993, to Dann teaches a hand-held cutter especially for mat or foam board comprising a body, with handle, carrying a sliding blade holder so that a cutting blade mounted on it can be extended for cutting, or withdrawn for safety when not in use; the holder is adapted to carry two parallel, spaced-apart blades when it is desired to make two parallel cuts in a board, and the body has an inclined-plane nose so the region between the two cuts can be “plowed out” to form a channel for receiving another piece of foam board. Each blade is mounted on an outboard side of the body so the blade and cut line can be easily seen during use. A clip-on angulation device is provided which, when clipped onto the bottom of the main body, provides an angled guide surface on which the body can be slid, when an angled cut is desired.

A SEVENTH EXAMPLE, U.S. Patent Office Document No. 6,745,478 B2, Issued on Jun. 08, 2004, to DeLillo teaches a multi-purpose work knife that includes a universal elongate ergonomically-shaped handle (UEH) which defines an axis and includes a blade having an UEH blade axis. Within the handle portion, a channel member is received in a forwardly extending cavity and movably receives a cutting blade carrier for axial movement relative to the handle portion. A selectable non-universal portion (SNP) is secured at one end to the UEH at a plane of continuity of curvature thru which the UEH axis passes. The SNP holds non-standard blade at an angular offset relative to the UEH axis. A cutting edge of the SNP blades defines a virtual angle which intersects the UEH axis within a range of 20 to 30 degrees.

It is apparent now that numerous innovations for cutting tools have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a scraper for removing nail heads and other debris from a surface that avoids the disadvantages of the prior art.

ANOTHER OBJECT of the present invention is to provide a scraper for removing nail heads and other debris from a surface that is simple and inexpensive to manufacture.

STILL ANOTHER OBJECT of the present invention is to provide a scraper for removing nail heads and other debris from a surface that is simple to use.

BRIEFLY STATED, STILL YET ANOTHER OBJECT of the present invention is to provide a scraper for removing nail heads and other debris from a surface which comprises a handle, a weighted cutting head and a mechanism for attaching the handle to the weighted cutting head. When a hand of a user grasps the handle and the weighted cutting head is moved upon the surface, sufficient momentum will be provided to easily scrape away the nail heads and the other debris with little effort.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view showing the present invention in use;

FIG. 2 is a diagrammatic exploded perspective view, with parts broken away, of the present invention per se;

FIG. 3 is an enlarged diagrammatic cross sectional view taken on line 3-3 in FIG. 2 of the cutting head;

FIG. 4 is an enlarged diagrammatic cross sectional view, with parts broken away, taken on line 4-4 in FIG. 1, showing the present invention in use slicing off some nail heads;

FIG. 5 is a diagrammatic perspective view of the present invention, with parts broken away, being utilized to scrape off a finish;

FIG. 6 is a diagrammatic perspective view of the present invention, with parts broken away, being utilized to remove a tackless carpet strip;

FIG. 7 is a diagrammatic perspective view of the present invention, with parts broken away, being utilized as a general purpose scraping tool; and

FIG. 8 is a diagrammatic exploded perspective view of the present invention, illustrating other alternative shaped cutting heads.

### A MARSHALLING OF REFERENCE NUMERALS UTILIZED IN THE DRAWING

10 scraper
12 nail head
14 debris
16 surface
18 handle of scraper 10
20 weighted cutting head of scraper 10
22 attaching mechanism of scraper 10
24 hand of user 26
26 user
28 shaft of handle 18
30 grip of handle 18
32 first end of shaft 28
34 flat-bottom base of handle 18
36 second end of shaft 28
38 body of weighted cutting head 20
40 heavy metal mass of body 38
42 sharp cutting edge of body 38
44 central aperture in flat-bottom base 34
46 central threaded aperture in weighted cutting head 20
48 bolt for attaching mechanism
49 wrench is provided for loosening and tightening the bolt 48
50 threaded shank of bolt 48
52 top channel of body 38
54 cross-shaped seat of top channel 52
56 securing structure of scrapper 10
58 first side of flat-bottom base 34
60 threaded aperture in first side 58
62 threaded lug on second end 36 of shaft 28
64 truncated pyramid shaped member of body 38
66 truncated cone shaped member of body 38
68 truncated trihedon shaped member of body 38
70 truncated four pointed star shaped member of body 38

### DETAILED DESCRIPTION OF THE PREFERRED EMBODIMENT

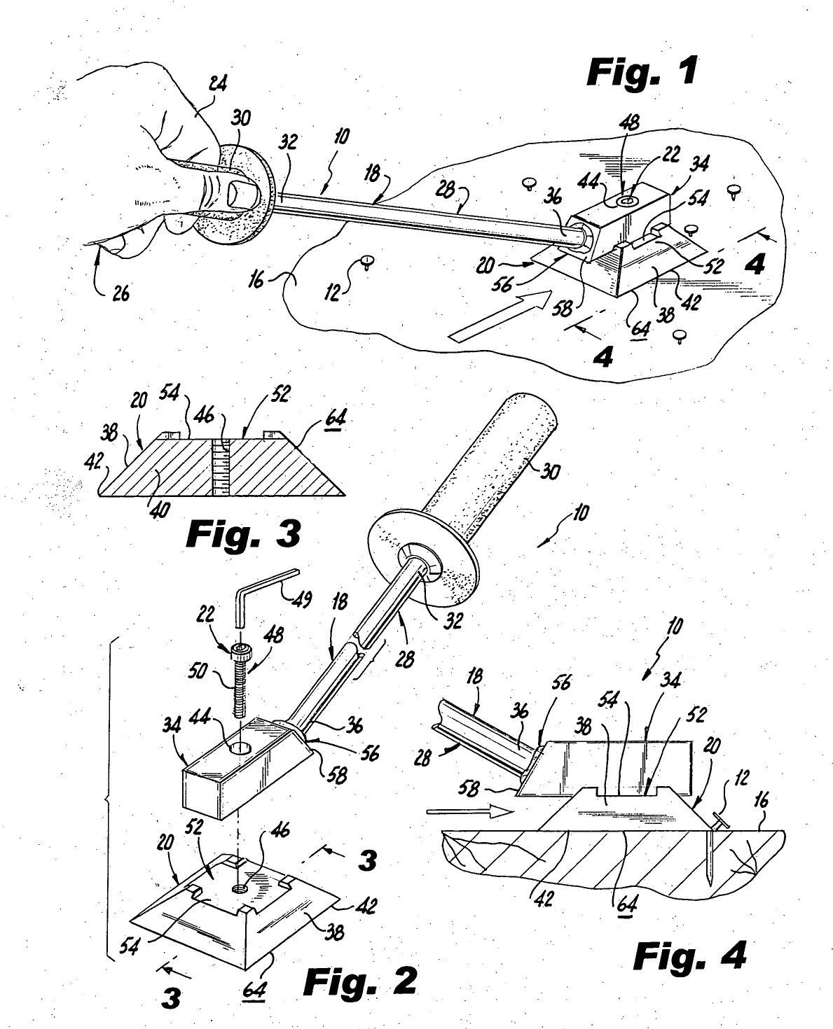

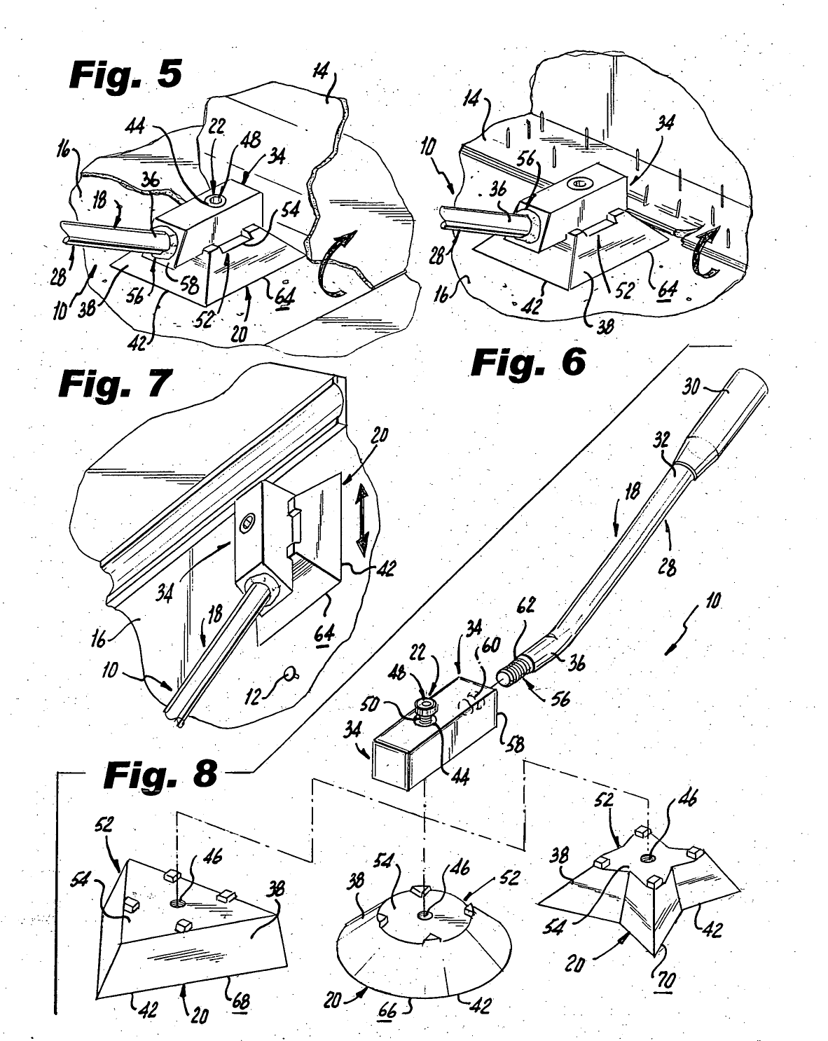

Referring now to FIGS. 1 through 8, in which like numerals indicate like parts, the present invention is a scraper 10 for removing nail heads 12 and other debris 14, such as a finish or a tackless carpet strip from a surface 16. The scraper 10 comprises a handle 18, a weighted cutting head 20 and a mechanism 22 for attaching the handle 18 to the weighted cutting head 20. When a hand 24 of a user 26 grasps the handle 18 and the weighted cutting head 20 is moved upon the surface 16, sufficient momentum will be provided to easily scrape away the nail heads 12 and the other debris 14 with little effort.

The handle 18 includes a shaft 28 and a grip 30 on a first end 32 of the shaft 28, wherein the grip 30 is grasped by the hand 24 of the user 26. A flat-bottom base 34 is on a second end 36 of the shaft 28. The weighted cutting head 20 includes a body 38 fabricated out of a heavy metal mass 40, having an outwardly angular sharp cutting edge 42 about a lower perimeter of the body 38. A head typically may be fabricated out of harden steel and have a weight in the range between of 0.5 to 10 pounds depending on the nature of the work and the preference of the user.

The attaching mechanism 22 consists of the flat-bottom base 34 having a central aperture 44 therethrough. The weighted cutting head 20 has a central threaded aperture 46 therethrough. A bolt 48 is provided having a threaded shank 50 that extends through the central aperture 44 in the flat-bottom base 34 and into the central threaded aperture 46 in the weighted cutting head 20. The bolt 48 will retain the flat-bottom base 34 onto the weighted cutting head 20. A wrench 49 is provided for loosening and tightening the bolt 48 when it is desired to exchange weighted cutting heads 20.

The body 38 of the weighted cutting head 20 has a top channel 52 sized to receive the flat-bottom base 34 thereon. The top channel 52 will maintain the flat-bottom base 34 to the body 38 of the weighted cutting head 20 in a stabilized manner when the flat-bottom base 34 is attached thereto. The top channel 52 in the body 38 of the weighted cutting head 20 is a cross-shaped seat 54, so that the flat-bottom base 34 can be attached to the body 38 of the weighted cutting head 20 in any one of four different positions.

The scraper 10 further contains a structure 56 for securing the second end 36 of the shaft 28 to a first side 58 of the flat-bottom base 34, so that the shaft 28 will extend upwardly at an angle from the first side 58 of the flat-bottom base 34. The securing structure 56, as shown in FIGS. 1, 2 and 4 through 7, is a weld 58 formed between the second end 36 of the shaft 28 and the first side 58 of the flat-bottom base 34, in which the first side 58 of the flat-bottom base 34 is angled inwardly.

The securing structure 56, as shown in FIG. 8, consists of the first side 58 of the flat-bottom base 34 having a threaded aperture 60 therein. The shaft 28 is bent near the second end 36 with the second end 36 having a threaded lug 62 thereon. The threaded lug 62 on the second end 36 of the shaft 28 will thread into the threaded aperture 60 in the first side 58 of the flat-bottom base 34.

As shown in FIGS. 1 through 7, the body 38 of the weighted cutting head 20 is a truncated pyramid shaped member 64. As shown in FIG. 8, the body 38 of the weighted cutting head 20 can also be a truncated cone shaped member 66, a truncated trihedron shaped member 68 or a truncated four pointed star shaped member 70.

It will be understood that each of the elements described above, or two or more together, may also find a useful application in other types of constructions differing from the types described above.

While the invention has been illustrated and described as embodiments of a scraper for removing nail heads and other debris from a surface, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A scraper for removing nail heads and other debris from a surface which comprises:
a handle;
a weighted cutting head, having a weight in a range between 0.5 and 10 pounds, a cutting edge extending completely around a lower perimeter of the cutting head and a flat bottom surface adapted to be slid along a surface to be scraped; and
means for attaching said handle to said weighted cutting head, wherein when a hand of a user grasps said handle and said weighted cutting head is moved upon the surfaces, sufficient momentum will be provided to easily scrape away the nail heads and the other debris with little effort.

2. The scraper as recited in claim 1, wherein said handle includes:
a shaft:
a grip on a first end of said shaft, wherein said grip is grasped by the hand of the user; and
a flat bottom base on a second end of said shaft.

3. The scraper as recited in claim 2, wherein said weighted cutting head includes a body fabricated out of a heavy metal mass having an outwardly angular cutting edge about a lower perimeter of said body.

4. The scraper as recited in claim 2, wherein said attaching means includes:
said flat-bottom base having a central aperture therethrough;
said weighted cutting head having a central threaded aperture therethrough; and
a bolt having a threaded shank that extends through said central aperture in said flat-bottom base and into said central threaded aperture in said weighted cutting head, wherein said bolt will retain said flat-bottom base onto said weighted cutting head.

5. The scraper as recited in claim 3, wherein said body of said weighted cutting head has a top channel sized to receive said flat-bottom base thereon, so that said top channel will maintain said flat-bottom base to said body of said weighted cutting head in a stabilized manner when said flat-bottom base is attached thereto.

6. The scraper as recited in claim 5, wherein said top channel in said body of said weighted cutting head is a cross-shaped seat, so that said flat-bottom base can be attached to said body of said weighted cutting head in one of four different positions.

7. The scraper as recited in claim 2, further comprising means for securing said second end of said shaft to a first side of said flat-bottom base, so that said shaft will extend upwardly at an angle from said first side of said flat-bottom base.

8. The scraper as recited in claim 7, wherein said securing means is a weld formed between said second end of said shaft and said first side of said flat-bottom base, in which said first side of said flat-bottom base is angled inwardly.

9. The scraper as recited in claim 7, wherein said securing means includes:
said first side of said flat-bottom base having a threaded aperture therein; and
said shaft being bent near said second end with said second end having a threaded lug thereon, so that said threaded lug on said second end of said shaft will thread into said threaded aperture in said first side of said flat-bottom base.

10. The scraper as recited in claim 3, wherein said body of said weighted cutting head is a truncated pyramid shaped member.

11. The scraper as recited in claim 3, wherein said body of said weighted cutting head is a truncated cone shaped member.

12. The scraper as recited in claim 3, wherein said body of said weighted cutting head is a truncated trihedron shaped member.

13. The scraper as recited in claim 3, wherein said body of said weighted cutting head is a truncated four pointed star shaped member.

14. A scraper comprising:
a handle;
a base carried by the handle;
a cutting head having a cross-shaped seat adapted to receive the base so that the base can be attached to the cutting head in more than one position; and
an attachment mechanism for attaching said handle to said cutting head.

15. The scraper as recited in claim 14 wherein the seat permits the base to be attached to the cutting head in four different positions.

16. The scraper as recited in claim 14 wherein the cutting head includes a cutting edge extending completely around a lower perimeter of the cutting head.
